(19) United States
(12) Patent Application Publication
(10) Pub. No.: US 2006/0165953 A1
(43) Pub. Date: Jul. 27, 2006

(54) Ring assembly for a covered paint robot

(75) Inventor: Mark Castelli, Warren, MI (US)

Correspondence Address: HARNESS, DICKEY & PIERCE, P.L.C., P.O. BOX 828, BLOOMFIELD HILLS, MI, 48303, US

(73) Assignee: T D Industrial Covering, Inc.

(21) Appl. No.: 11/285,620

(22) Filed: Nov. 22, 2005

Related U.S. Application Data
(60) Provisional application No. 60/631,770, filed on Nov. 29, 2004.

(51) Int. Cl. B32B 3/06

(52) U.S. Cl. 428/99

(57) ABSTRACT

A ring assembly for an automated paint robot having an axis of rotation includes a plurality of ring structures. Mounting brackets extend from the ring assembly and secure the ring assembly to the paint robot proximate the axis of rotation. The ring structures are oriented in a plane substantially perpendicular to the axis of rotation. In various embodiments, the ring assembly further comprises a second substantially circular ring connected and parallel to a first substantially circular ring.

### CROSS-REFERENCE TO RELATED APPLICATIONS

This application claims the benefit of U.S. Provisional Application No. 60/631,770, filed on Nov. 29, 2004.

### FIELD

The present disclosure generally relates to the protection of paint robots from overspray paint. More specifically, the present disclosure relates to improvements in preventing a paint robot cover from being twisted and caught in a paint robot axis.

### BACKGROUND

The statements in this section merely provide background information related to the present disclosure and may not constitute prior art.

Painted goods such as automobiles and the like conventionally utilize a dedicated paint area or paint room for the application of paint. The paint rooms are highly regulated to promote a quality paint finish. For example, most conventional clothing is prohibited due to the loose fibers which otherwise end up in the paint. Additionally, various lotions and other personal products are prohibited due to their adverse effect on the painting process.

In many applications, paint is applied to articles such as automobiles with automated paint robots. The robots advantageously eliminate human error, reduce labor and provide improved and repeatable quality. The application of paint with automated paint robots is necessarily associated with a degree of overspray. Some overspray of paint is required to ensure complete painting of the subject article.

It has heretofore been appreciated in the pertinent art that automated paint robots can be equipped with cloth covers to both protect the robot and reduce paint defects. In this regard, the cloth covers substantially shield the robots from paint overspray, thereby protecting the moving parts. Additionally, the cloth covers prevent the accumulation of paint that may otherwise result in the dripping of paint on the subject article. The covers can be periodically discarded and replaced. One known robot cover is shown and described in commonly owned U.S. Ser. No. 10/874,909, filed Jun. 23, 2004. U.S. Ser. No. 10/874,909 is hereby incorporated by reference as if fully set forth herein.

While known robot covers, including the type disclosed by U.S. Ser. No. 10/874,909, have proven to be suitable for their intended purpose, a need for continued improvement remains in the pertinent art.

### SUMMARY

The present disclosure provides a ring assembly for an automated paint robot having an axis of rotation. The ring assembly is used in combination with a cover and is comprised of a plurality of ring structures and a mounting structure for securing at least one ring structure to the paint robot proximate the axis of rotation. The rings are further oriented in a plane substantially perpendicular to the axis of rotation.

In various embodiments, the ring assembly of the disclosure comprises of a second substantially circular ring connected to a first substantially circular ring. The second substantially circular ring may be generally parallel to the first substantially parallel ring. The first and second substantially circular rings of the ring assembly may also be connected by a plurality of stanchions. The ring assembly may be constructed of a material or materials having suitable strength and durability characteristics. A preferable example of a material suitable for use in the ring assembly is aluminum.

Further areas of applicability will become apparent from the description provided herein. It should be understood that the description and specific examples are intended for purposes of illustration only, and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of a robot cover installed on a robot, a ring assembly constructed in accordance with the teachings of the present disclosure mounted to the robot to facilitate freedom of movement of the robot relative to the cover.

FIG. 2 is a perspective view similar to FIG. 1, illustrated with the robot cover removed for purposes of illustration.

FIG. 3 is a perspective view of the ring assembly constructed in accordance with the teachings of the present disclosure.

FIG. 4 is a perspective view of another ring assembly constructed in accordance with the teachings of the present disclosure.

### DETAILED DESCRIPTION

The following description of the present disclosure is understood to be merely exemplary in nature and is in no way intended to limit the disclosure, its application, or uses. It should be understood that throughout the drawings, corresponding reference numerals indicate like or corresponding parts and features.

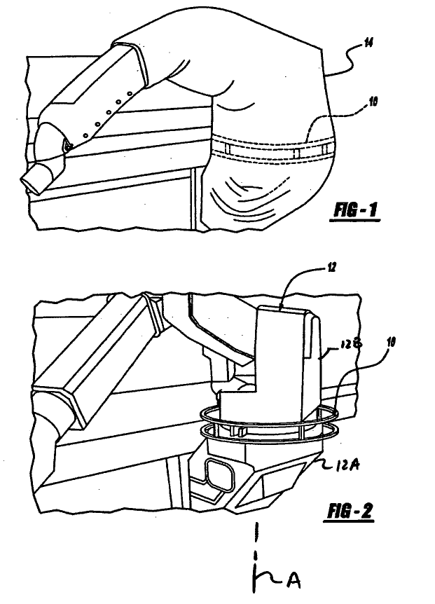

With initial reference to FIGS. 1 and 2, a ring assembly constructed in accordance with the teachings of the present disclosure is illustrated in hidden lines and generally identified at reference character 10. In a manner to be discussed below, the ring assembly 10 is operatively installed on a paint robot 12. The paint robot 12 is fitted with a cover 14.

In the embodiment illustrated, the paint robot 12 is manufactured and sold by Fanuc Robotics under the mark P-200. One suitable paint cover is shown and described in U.S. Ser. No. 10/874,909. The paint robot illustrated will be understood to include a lower portion or base 12A and an upper portion 128. The lower portion 12A is adapted to translate along a rail. The upper portion 128 may rotate relative to the lower portion 12A about an axis A. Those skilled in the art, however, will appreciate that various teachings of the present disclosure are equally applicable to other robots and other covers.

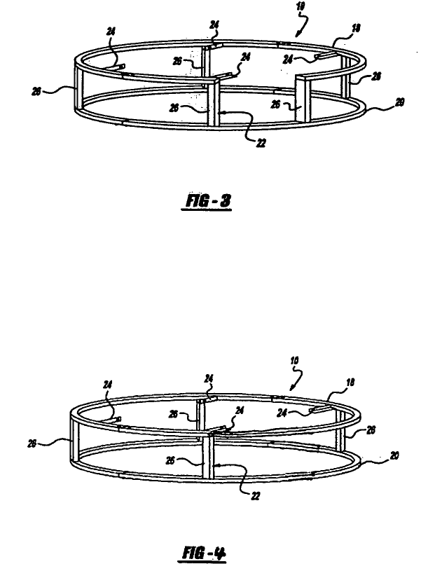

With continued reference to FIGS. 1 and 2, and additional reference to FIG. 3, the ring assembly 10 will be further described. The ring assembly 10 is generally illustrated to include a plurality of substantially circular ring structures connected in a generally parallel orientation. Those skilled in the art will appreciate that substantially circular rings may include rings that are generally circular, ellipsoidal, or even polygonal in shape. In the embodiment illustrated, the ring assembly 10 includes first substantially circular ring 18 and second substantially circular ring 20. Although the embodiment illustrated includes only two rings, one skilled in the art will readily appreciate that a single ring or a greater number of rings may be used.

For certain applications, the first ring 18 may define a notch 22 (see FIG. 3) to accommodate the gun of the paint robot 12 during mastering. In other applications (see FIG. 4), the notch is not necessary.

The ring assembly 10 may include mounting structures extending from the first ring 18 for securing the first substantially circular ring 18 to the paint robot 12 proximate the axis of rotation. The first substantially circular ring 18 may be oriented in a plane substantially perpendicular to the axis of rotation. Alternatively, the second ring 20 may be secured to the paint robot by mounting structures extending from the second ring. In a further alternative, both the first substantially circular ring 18 and the second substantially circular ring 20 may be secured by mounting structures extending from both rings. The mounting structures may include a plurality of mounting brackets 24. In the embodiment illustrated, the ring assembly 10 includes four (4) mounting brackets 24 extending from the first substantially circular ring 18. The mounting brackets 24 may allow the ring assembly 10 to be mounted to the turret of the robot 12 using existing bolt holes in the four lower corners.

The first and second substantially circular rings 18 and 20 may be connected in a generally parallel orientation. The rings 18 and 20 may be connected by a plurality of stanchions 26. In the embodiment illustrated, five (5) stanchions connect the first and second rings 18 and 20.

The ring assembly 10 may be constructed of any material having suitable strength and durability characteristics. In one particular application, the ring assembly 10 is constructed of aluminum and has a diameter of approximately 43 inches. In this particular application, the stanchions 26 have a height of approximately 4 inches.

Accordingly, the present disclosure provides a ring assembly 10 for a paint robot 12 that prevents a robot cover 14 from getting twisted and caught in an axis of rotation of the robot 12.

The description of the disclosure is merely exemplary in nature and, thus, variations that do not depart from the gist of the disclosure are intended to be within the scope of the disclosure. Such variations are not to be regarded as a departure from the spirit and scope of the disclosure.

I Claim:

1. A ring assembly for an automated paint robot having an axis of rotation in combination with a cover, the ring assembly comprising:
a plurality of ring structures, at least one of which may be secured by mounting structures extending from the ring assembly to the paint robot, proximate the axis of rotation, the plurality of ring structures oriented in a plane substantially perpendicular to the axis of rotation.

2. The ring assembly of claim 1, wherein the ring structures are substantially circular in shape.

3. The ring assembly of claim 1, wherein each of the ring structures are generally parallel to each of ring structures.

4. The ring assembly of claim 1, wherein the plurality of ring structures are connected by a plurality of stanchions.

5. The ring assembly of claim 1 in combination with the automated paint robot.

6. A ring assembly for an automated paint robot having an axis of rotation in combination with a cover, the ring assembly comprising:
a first substantially circular ring; and
mounting structures extending from the ring assembly for securing the first substantially circular ring to the paint robot proximate the axis of rotation, the first substantially circular ring oriented in a plane substantially perpendicular to the axis of rotation.

7. The ring assembly of claim 6, further comprising a second substantially circular ring connected to the first substantially circular ring, the second substantially circular ring being generally parallel to the first substantially parallel ring.

8. The ring assembly of claim 7, wherein the second substantially circular ring is secured to the paint robot proximate the axis of rotation by mounting structures extending from the second substantially circular ring.

9. The ring assembly of claim 7, wherein the first and second substantially circular rings are connected by a plurality of stanchions.

10. The ring assembly of claim 6, wherein the ring assembly is constructed of aluminum.

11. The ring assembly of claim claim 6 in combination with the automated paint robot.
